(19) United States
(12) Patent Application Publication
(10) Pub. No.: US 2007/0197371 A1
(43) Pub. Date: Aug. 23, 2007

(54) Dielectric glass-ceramic composition, dielectric glass-ceramic substrate and manufacturing method thereof

(75) Inventors: Chih-Hung Wei, Taoyuan Hsien (TW); Yu-Ping Hsieh, Taoyuan Hsien (TW); Chin-Yuan Chiu, Taoyuan Hsien (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/699,028

(22) Filed: Jan. 29, 2007

(30) Foreign Application Priority Data
Feb. 17, 2006 (TW) 095105311

(51) Int. Cl. C04B 35/47; C03C 14/00

(52) U.S. Cl. 501/136; 501/32

(57) ABSTRACT

A dielectric glass-ceramic substrate composed of a dielectric glass-ceramic composition is disclosed. The dielectric glass-ceramic composition includes a ceramic material and a Ba—B—Si glass material. Also, a method of manufacturing a dielectric glass-ceramic substrate includes steps of: mixing a ceramic material and a Ba—B—Si glass material with an organic carrier, forming the ceramic material, the Ba—B—Si glass material and the organic carrier as a pre-mold; and firing the pre-mold to form the dielectric glass-ceramic substrate at a low temperature.

This Non-provisional application claims priority under U.S.C. §119(a) on Patent Application No(s). 095105311, filed in Taiwan, Republic of China on Feb. 17, 2006, the entire contents of which are hereby incorporated by reference.

### BACKGROUND OF THE INVENTION

1. Field of Invention

The invention relates to a dielectric glass-ceramic composition, and in particular to a dielectric glass-ceramic composition, a dielectric glass-ceramic substrate and a manufacturing method thereof, which are applicable to a low temperature co-fired process.

2. Background

Recently, portable electronic products and mobile communication products have been developed according to trends of miniaturization, multifunctionality, high reliability and low cost, such that the element density in electronic products has become higher and higher. Also, the circuits of active and passive devices are developed in the directions of integration, on-chip package and modularization.

The development of low temperature co-fired ceramics (LTCC) technology makes it possible to increase the volume availability of electronic products, wherein the electrical elements, including passive devices, active devices and circuits are mainly integrated in a multi-layer structure to reduce the volume. FIG. 1 is a schematically cross-sectional view showing a substrate 1 used in a conventional high-frequency wireless communication element. As shown in FIG. 1, the substrate 1 is a multi-layer structure by using glass and ceramics to form a base material. Each layer 11 is printed with a conductive metal layer 111. Same electrical elements 112, such as resistors, capacitors or inductors, are embedded in the substrate 1. The conductive metal layer 111 can be electrically connected to the electrical elements 112 in the layers 11 through vias 113. The conductive metal layer 111 or the electrical elements 112 is formed on a surface of one of the layers 11 by way of a thick film printing technology, and then multiple layers are laminated and sintered at a temperature below 1000° C.

However, the base material has to be carefully selected according to the considerations of the parameters such as dielectric constant (ε), dielectric loss (tan δ) and so on. The dielectric constant influences the physical volume of the manufactured element, and a higher dielectric constant corresponds to a smaller element volume. A lower dielectric loss represents a smaller signal energy loss and a higher quality factor (Q). In addition, a typical conductive metal layer is frequently made of a material, such as silver (Ag), which has low impedance and low dielectric loss, and is then co-fired with the base material. However, because silver metal has a melting point of 962° C., the selection of the base material has to be considered whether the base material and the conductive metal layer can be co-fired below the melting point of the conductive metal.

In view of this, it is one important subject of the invention to provide a dielectric glass-ceramic substrate and a manufacturing process thereof in which the dielectric glass-ceramic composition can be sintered at a low temperature and in which the glass-ceramic substrate end-product satisfies the requirements of volume minimization, high quality and high stability,

### SUMMARY OF THE INVENTION

It is therefore an object of the invention to provide a dielectric glass-ceramic composition, which can be applied to a low temperature co-fired process and satisfy the requirements of volume minimization, high quality and high stability, a dielectric glass-ceramic substrate made of a dielectric glass-ceramic composition, and a method of manufacturing the dielectric glass-ceramic substrate.

The invention achieves the above-identified object by providing a dielectric glass-ceramic composition including a ceramic material and a Ba—B—Si glass material. The ceramic material may be, for example, a strontium titanate ceramic powder or a commercial dielectric ceramic powder.

The invention achieves the above-identified object by providing a dielectric glass-ceramic substrate composed of a dielectric glass-ceramic composition, wherein the dielectric glass-ceramic composition comprises a ceramic material and a Ba—B—Si glass material.

The invention achieves the above-identified object by providing a method of manufacturing a dielectric glass-ceramic substrate, the method comprising the steps of: mixing a ceramic material and a Ba—B—Si glass material with an organic carrier; forming the ceramic material, the Ba—B—Si glass material and the organic carrier as a pre-mold; and sintering the pre-mold to form the dielectric glass-ceramic substrate at a low temperature.

As mentioned hereinabove, the Ba—B—Si glass material and the ceramic material are mixed with an organic carrier in the dielectric glass-ceramic composition. In the dielectric glass-ceramic substrate and manufacturing method thereof according to the preferred embodiment, the Ba—B—Si glass material mainly includes barium, boron oxide and silicon oxide. Thus, it is possible to lower the sintering temperature of the dielectric glass-ceramic composition effectively. Furthermore, a conductive material with a melting point lower than that permitted by the prior art can be co-fired to with the dielectric glass-ceramic composition to form the dielectric glass-ceramic substrate using the LTCC technology.

Compared with the prior art, the present invention achieves a more favorable dielectric constant and higher quality factor by mixing the ceramic material with the Ba—B—Si glass material according to a proper ratio. Thus, high quality and high stability can be obtained while minimizing the element volume.

### BRIEF DESCRIPTION OF THE DRAWINGS

The invention will become more fully understood from the detailed description given herein below illustration only, and thus is not limitative of the present invention, and wherein:

FIG. 1 is a schematic cross-sectional view showing a substrate used in a conventional high-frequency wireless communication element; and

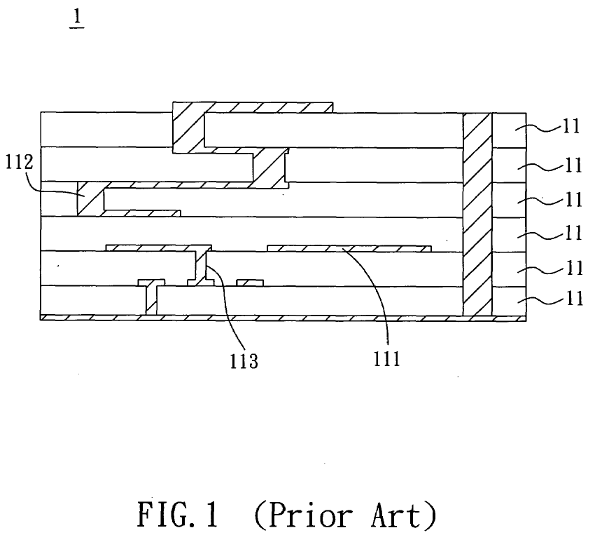

FIG. 2 is a flow chart showing a method of manufacturing a dielectric glass-ceramic substrate according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

A dielectric glass-ceramic substrate according to a preferred embodiment of the invention is composed of a dielectric glass-ceramic composition. Herein, the dielectric glass-ceramic substrate is a low temperature co-fired ceramic substrate.

It is well known in the art that the strontium titanate has the high dielectric constant and the high resonance frequency temperature coefficient. The strontium titanate has the following properties:
(1). sintering temperature: higher than 1300° C.;
(2). dielectric constant (@GHz): 200; and
(3). temperature coefficient: 1100 ppm/° C.

Furthermore, the typical commercial dielectric ceramic powder also has a corresponding dielectric constant, sufficient quality factor and a lower resonance frequency temperature coefficient. The typical commercial dielectric ceramic powder has the following properties:
(1). sintering temperature: 1350° C.;
(2). dielectric constant (@GHz): 36.5;
(3). quality coefficient (@5.21 GHz): 11000; and
(4). temperature coefficient (ppm/° C.): −2.8(from 25° C. to 125° C.).

As shown in the above-mentioned data, the sintering temperatures of the strontium titanate ceramic powder and the commercial dielectric ceramic powder are higher than 1300° C. and thus they cannot satisfy the requirement of being lower than 962° C. In addition, the temperature coefficient cannot satisfy the specification. Therefore, the dielectric glass-ceramic composition according to the preferred embodiment uses a ceramic material and a Ba—B—Si glass material, of which the sintering temperature can be effectively lowered to 962° C. or lower, such that a high-frequency laminated ceramic element co-fired with a high conductivity metal, such as silver, can be obtained.

The ceramic material may be, for example, strontium titanate ceramic powder or commercial dielectric ceramic powder with a dielectric constant of 30 to 40. Preferably, the dielectric glass-ceramic composition may be composed of 45 wt % to 75 wt % of strontium titanate ceramic material and 25 wt % to 55 wt % of Ba—B—Si glass material. In this example, the dielectric glass-ceramic composition is most preferably composed of 60 wt % to 75 wt % of strontium titanate ceramic material and 25 wt % to 40 wt % of Ba—B—Si glass material. Alternatively, the dielectric glass-ceramic composition is composed of 45 wt % to 75 wt % of commercial dielectric ceramic powder and 25 wt % to 55 wt % of Ba—B—Si glass material. In this alternate example, the dielectric glass-ceramic composition is most preferably composed of 70 wt % to 80 wt % of commercial dielectric ceramic powder and 20 wt % to 30 wt % of Ba—B—Si glass material.

In this embodiment, the composition of the Ba—B—Si glass material includes 0 wt % to 10 wt % of barium, 70 wt % to 80 wt % of boron oxide, 10 wt % to 20 wt % of silicon oxide and 0 wt % to 5 wt % of potassium oxide. More specifically, an ideal composition of the Ba—B—Si glass material includes 5 wt % of barium, 77 wt % of boron oxide, 16 wt % of silicon oxides and 2 wt % of potassium oxide.

As mentioned hereinabove, the dielectric glass-ceramic substrate of this embodiment is manufactured by mixing the ceramic material with the Ba—B—Si glass material and an organic carrier. In practice, 29 wt % to 49 wt % of the ceramic material, 16 wt % to 36 wt % of the Ba—B—Si glass material and 35 wt % to 45 wt % of the organic carrier are mixed and then co-fired at the temperature lower than 962° C. to form the substrate. The organic carrier includes a binder, an organic solvent or a plasticizer. In this embodiment, the binder may be Polyethylene Glycol (PEG), Polyvinyl Butyral (PVB) or Polyvinyl Alcohol (PVA). The organic solvent may be n-Propyl Alcohol, Toluene or Ethanol. And, the plasticizer is Dibutyl Phthalate (DBP).

The dielectric glass-ceramic composition is preferably composed of 29 wt % to 50 wt % of the ceramic material and 15 wt % to 36 wt % of Ba—B—Si glass material, more preferably composed of 40 wt % to 45 wt % of strontium titanate ceramic and 20 wt % to 25 wt % of Ba—B—Si glass material, or most preferably composed of 45 wt % to 50 wt % of commercial dielectric ceramic powder and 15 wt % to 20 wt % of Ba—B—Si glass material.

In this embodiment, the co-fired dielectric glass-ceramic substrate may be applied to a micro-wave communication assembly, especially a high-frequency filter, such as a filter having an inner conductor layer or a strip line filter. In the electronic assembly used in the dielectric glass-ceramic substrate, the dielectric glass-ceramic composition has a dielectric constant (ε) ranging from 9 to 33 and a quality factor (Q) ranging from 400 to 6000 at 1 MHz. Thus, the present embodiment can minimize the volume of the electronic assembly and satisfy the standards of the micro-wave communication assembly.

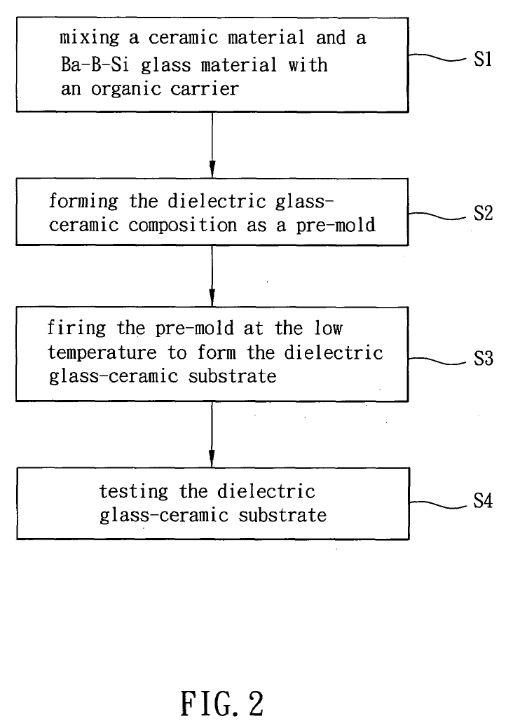

As shown in FIG. 2, a method of manufacturing the dielectric glass-ceramic substrate according to the preferred embodiment of the invention includes steps S1 to S3. Step S1 mixes a ceramic material and a Ba—B—Si glass material with an organic carrier. Step S2 forms the dielectric glass-ceramic composition as a pre-mold. Step S3 fires the pre-mold at a low temperature to form the dielectric glass-ceramic substrate.

The method of manufacturing the dielectric glass-ceramic substrate according to this embodiment may further include a step S4 of testing the dielectric glass-ceramic substrate after step S3.

Because of the material selection, the mixing ratio and the features of the ceramic material, the Ba—B—Si glass material and the organic carrier in the dielectric glass-ceramic composition of this embodiment have been described in the above-mentioned embodiment, detailed descriptions thereof will be omitted. Herein, the dielectric glass-ceramic substrate is a ceramic substrate co-fired at a sintering temperature lower than 962° C.

In order to make the invention more easily understood, two experimental examples will be described in the following.

### FIRST EXPERIMENTAL EXAMPLE

First, the powder containing the strontium titanate ceramic material, and the powder containing the Ba—B—Si glass material and the organic carrier are mixed according to different weight percentages shown in Table 1. Next, 10 grams of the mixed powder is taken out and mixed with 10 ml of 1-propyl alcohol, 5 wt % of polyethylene glycol 200 (PEG 200) and ten zirconium oxide grinding balls, each of which has a diameter of about 10 mm. Then, a 3-D cantilever-arm powder mixing machine is used to perform the mixing procedure for about two hours. Next, the mixed powder is dried for one hour at 80° C. and then ground by a mortar and a pestle. Thereafter, 2.5 grams of powder is taken out and placed into a circular compressing mold having a diameter of 15 mm, and a pressure of 9 MPa is provided for 15 seconds to press the mixed powder into a pre-mold.

Thereafter, the pre-mold is fired for 15 to 30 minutes in an atmosphere ranging from 875° C. to 900° C. The sintering process is divided into two stages. The first stage is to remove the grease. That is, the organic binder in the pre-mold is slowly removed by heating the pre-mold at the heating speed of 5° C./min. In order to remove the organic binder completely, the pre-mold is kept at a temperature of 500° C. for one hour. The second stage is to sinter the pre-mold by heating the pre-mold to the sintering temperature at a heating speed of 5 to 15° C./min. The pre-mold is kept at the sintering temperature for 15 to 120 minutes and then cooled in the furnace. The dielectric glass-ceramic substrate is thus manufactured.

After the sintering process, a LCR meter is used in measuring the low-frequency property at 1 MHz, and the Hakki and Coleman method is used in measuring the dielectric constant and the quality factor of the dielectric glass-ceramic composition in the dielectric glass-ceramic substrate. The results obtained in this experimental example are listed in Table 1 as below.

TABLE 1

| Ba—B—Si | | Dielectric | Quality | Dielectric | |
|---|---|---|---|---|---|
| glass | Strontium | constant | facto | constant | Product of quality |
| material | titanate ceramic | (K) | (Q) | (K) | factor and resonance |
| (wt %) | material (wt %) | @1 MHz | @1 MHz | @1 GHz | frequency (Q × f) |
| 25.7 | 74.3 | 32.3 | 1361 | | |
| 34.1 | 65.9 | 30.9 | 1992 | 30.3 | 2163 |
| 43.7 | 56.3 | 16.7 | 445 | | |
| 54.7 | 45.3 | 9.5 | 237 | | |

### SECOND EXPERIMENTAL EXAMPLE

First, the powder containing the NPO37 medium ceramics, and the powder containing the Ba—B—Si glass material and the organic carrier are mixed according to different weight percentages shown in Table 2. Next, 10 grams of the mixed powder is taken out to mix with 10 ml of 1-propyl alcohol, 5 wt % of polyethylene glycol 200 (PEG 200) and ten zirconium oxide grinding balls each having a diameter of about 10 mm. Then, a 3-D cantilever-arm powder mixing machine is used to perform the mixing for about two hours. Next, the mixed powder is fired for one hour at 80° C. and then ground by a mortar and a pestle. Thereafter, 2.5 grams of powder is taken out and placed into a circular compressing mold having a diameter of 15 mm, and a pressure of 9 MPa is provided for 15 seconds to press the powder into the pre-mold.

Thereafter, the pre-mold is sintered for 15 to 30 minutes in an atmosphere ranging from 875° C. to 900° C. The firing process is divided into two stages. The first stage is to remove the grease. That is, the organic binder in the pre-mold is slowly removed by heating the pre-mold at a heating speed of 5° C./min. In order to remove the organic binder completely, the pre-mold is kept at the temperature of 500° C. for one hour. The second stage is to sinter the pre-mold by heating the pre-mold to the sintering temperature at a heating speed of 5 to 15° C./min. The pre-mold is kept at the sintering temperature for 15 to 120 minutes and then cooled in the furnace. The dielectric glass-ceramic substrate is thus manufactured.

After the sintering process, a LCR meter is used in measuring the low-frequency property at 1 MHz, and the Hakki and Coleman method is used in measuring the dielectric constant and the quality factor of the dielectric glass-ceramic composition in the dielectric glass-ceramic substrate. The results obtained in this experimental example are listed in Table 2 as below.

TABLE 2

| | | | | | Product of |
|---|---|---|---|---|---|
| Ba—B—Si | commercial | Dielectric | | Dielectric | quality factor |
| glass | dielectric | constant | | constant | and resonance |
| material | ceramic | (K) | Quality facto (Q) | (K) | frequency |
| (wt %) | powder (wt %) | @1 MHz | @1 MHz | @1 GHz | (Q × f) |
| 26.4 | 73.6 | 22.87 | 969 | 23.7 | 5991 |
| 35.0 | 65.0 | 21.61 | 690 | | |

The dielectric glass-ceramic substrate that has been manufactured and tested in this embodiment may be applied to a micro-wave communication assembly, especially a filter, such as a filter having an inner conductor layer or a strip line filter. As mentioned hereinabove, the dielectric constant (ε) of the dielectric glass-ceramic composition ranges from 9 to 33 at 1 MHz, and the quality factor (Q) of the dielectric glass-ceramic composition ranges from 400 to 6000 at 1 MHz.

In summary, the invention discloses a dielectric glass-ceramic composition, a dielectric glass-ceramic substrate and a manufacturing method, wherein the dielectric glass-ceramic composition is composed of the Ba—B—Si glass material and the ceramic material. The Ba—B—Si glass material is mainly composed of barium, boron oxide and silicon oxide so that the sintering temperature thereof can be effectively lowered. Consequently, the Ba—B—Si glass material and the conductive material with the lower melting point may be sintered to form a dielectric glass-ceramic substrate according to low temperature co-fired ceramics technology. Compared with the prior art, the invention can properly mix the ceramic material with the Ba—B—Si glass material according to a proper ratio so as to obtain a better dielectric constant and a better quality factor. Thus, high quality and high stability can be achieved while minimizing the volume.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dielectric glass-ceramic composition, comprising:
a ceramic material and a Ba—B—Si glass material.

2. The composition according to claim 1, wherein a weight percentage of the ceramic material is ranged from 45% to 75%, and a weight percentage of the Ba—B—Si glass material is ranged from 25% to 55%.

3. The composition according to claim 2, wherein the ceramic material is strontium titanate ceramics.

4. The composition according to claim 1, wherein the ceramic material is a commercial dielectric ceramic powder with a dielectric constant ranged from 30 to 40.

5. The composition according to claim 4, wherein a weight percentage of the ceramic material is ranged from 70% to 80%, and a weight percentage of the Ba—B—Si glass material is ranged from 20% to 30%.

6. The composition according to claim 1, wherein the Ba—B—Si glass material includes 0 wt % to 10 wt % of barium, 70 wt % to 80 wt % of boron oxide, 10 wt % to 20 wt % of silicon oxide and 0 wt % to 5 wt % of potassium oxide.

7. The composition according to claim 1, wherein the composition at a frequence of 1 MHz has a dielectric constant (ε) ranged from 9 to 33.

8. The composition according to claim 1, wherein the composition at a frequence of 1 MHz has a quality factor (Q) ranged from 400 to 6000.

9. A dielectric glass-ceramic substrate composed of a dielectric glass-ceramic composition, wherein the dielectric glass-ceramic composition comprises a ceramic material and a Ba—B—Si glass material.

10. The substrate according to claim 9, wherein the substrate further comprises an organic carrier, which is mixed with the ceramic material and the Ba—B—Si glass material.

11. The substrate according to claim 10, wherein the organic carrier includes a binder, an organic solvent and a plasticizer.

12. The substrate according to claim 10, wherein the binder is Polyethylene Glycol, Polyvinyl Butyral or Polyvinyl Alcohol.

13. The substrate according to claim 10, wherein the organic solvent is 1-Propyl Alcohol, Toluene or Ethanol.

14. The substrate according to claim 10, wherein the plasticizer is Dibutyl Phthalate.

15. The substrate according to claim 9, wherein the substrate is a low temperature co-fired ceramics substrate (LTCC), and the low temperature co-fired ceramics substrate is co-fired at a sintering temperature is lower than 962° C.

16. A method of manufacturing a dielectric glass-ceramic substrate, the method comprising steps of:
mixing a ceramic material and a Ba—B—Si glass material with an organic carrier;
forming the ceramic material, the Ba—B—Si glass material and the organic carrier as a pre-mold; and
firing the pre-mold to form the dielectric glass-ceramic substrate at a low temperature.

17. The method according to claim 16, wherein the pre-mold are formed by drying for about one hour and pressing.

18. The method according to claim 16, wherein the step of firing the pre-mold at the low temperature comprises a grease removing stage and a sintering stage.

19. The method according to claim 16, wherein after the step of firing at the low temperature, the method further comprises a step of:
testing the dielectric glass-ceramic substrate.

20. The method according to claim 19, wherein in the step of testing the dielectric glass-ceramic substrate, a LCR meter is used in measuring a low-frequency property of the composition at a frequence of 1 MHz, and a Hakki and Coleman method is used in measuring a dielectric constant and a quality factor of the composition.
